(19) United States
(12) Patent Application Publication
(10) Pub. No.: US 2007/0256046 A1
(43) Pub. Date: Nov. 1, 2007

(54) Analysis and optimization of manufacturing yield improvements

(75) Inventors: Fedor G. Pikus, Beaverton, OR (US); Steven William LoBasso, Sherwood, OR (US); Robin Kirk Albrecht, Beavercreek, OR (US); Sridhar Srinjvasan, Tualatin, OR (US)

Correspondence Address: BANNER & WITCOFF, LTD., 1100 13th STREET, N.W., SUITE 1200, WASHINGTON, DC, 20005-4051, US

(73) Assignee: Mentor Graphics Corp., Wilsonville, OR (US)

(21) Appl. No.: 11/415,441

(22) Filed: Apr. 30, 2006

(51) Int. Cl. G06F 17/50

(52) U.S. Cl. 716/16; 716/4

(57) ABSTRACT

Techniques for improving the design of circuits, such as integrated microcircuits. A proposed circuit design is analyzed to identify design features associated with yield loss in manufactured circuits. Corrective design changes that will reduce the yield losses associated with the yield loss features then are designated. Once the corrective design changes have been determined, the corrective design changes that will optimize the manufacturing yield of the circuit are selected and incorporated into the circuit design. This analysis and revision process may then be repeated for each revised circuit design, until no further reduction in the manufacturing can be obtained.

### FIELD OF THE INVENTION

The present invention relates to various techniques and tools to assist in the design of circuits, such as integrated circuits. Various aspects of the present invention are particularly applicable to selecting and implementing changes to a circuit design that will improve the yield of circuits manufactured from the design.

### BACKGROUND OF THE INVENTION

Electronic circuits, such as integrated microcircuits, are used in a variety of products, from automobiles to microwaves to personal computers. Designing and fabricating microcircuit devices typically involves many steps, known as a “design flow.” The particular steps of a design flow are highly dependent upon the type of microcircuit, its complexity, the design team, and the microcircuit fabricator or foundry that will manufacture the microcircuit. Software and hardware “tools” then verify the design at various stages of the design flow by running software simulators and/or hardware emulators, and errors in the design are corrected.

Several steps are common to all design flows. First, the specifications for the new microcircuit are described in terms of logical operations, typically using a hardware design language (HDL), such as VHDL. After the accuracy of the logical design is confirmed, the logical design is converted into device design data by synthesis software. The device design data, or schematics, represents the specific electronic devices, such as transistors, resistors, and capacitors, which will achieve the desired logical result and their interconnections. Preliminary timing estimates for portions of the circuit may also be made at this stage, using an assumed characteristic speed for each device. These schematics generally correspond to the level of representation displayed in conventional circuit diagrams.

Once the relationships between circuit devices have been established, the design is again transformed into physical design data describing specific geometric elements. These geometric elements, often referred to as a “layout” design, define the shapes that will be created in various materials to form the specified circuit devices. Custom layout editors, such as Mentor Graphics' IC Station or Cadence's Virtuoso are commonly used for this task. Automated place and route tools also will frequently be used to define the physical layouts, especially of wires that will be used to interconnect the circuit devices. Each layer of the microcircuit will have a corresponding layer representation in the layout design, and the geometric shapes described in a layer representation will define the relative locations of the circuit elements that will make up the circuit device. For example, the shapes in the layer representation of an implant layer will define the regions where doping will occur, while the shapes in the layer representation of a metal layer will define the locations of the metal wires used to connect the circuit devices. Thus, the layout design data represents the patterns that will be written onto masks to fabricate the desired microcircuit using, for example, photolithographic processes.

As the importance of microcircuits grows, designers and manufacturers continue to improve these devices. Each year, for example, microcircuit device manufacturers develop new techniques that allow microcircuit devices, such as programmable microprocessors, to be more complex and smaller in size. Microprocessors are now manufactured with over 50 million transistors, many with dimensions of only 90 nm. Moreover, many manufacturers are now employing these techniques to manufacture other types of microdevices, such as optical devices, photonic structures, mechanical machines or other micro-electromechanical systems (MEMS) and static storage devices. These other microdevices show promise to be as important as microcircuit devices are currently.

As microcircuits become more complex, they also become more difficult to manufacture. A conventional microcircuit, for example, may have many millions of connections between the circuit devices. If a circuit device or connection is not properly formed during the manufacturing process, the microcircuit may operate incorrectly or even fail altogether. Thus, not only must the circuit be properly designed, but it must be manufactured with as few defects as possible. A higher probability of a defect occurring in individual circuits will result in a lower overall manufacturing yield for the circuit.

The task of minimizing defects created during the manufacturing process traditionally has been the responsibility of integrated circuit wafer manufacturing engineers. These manufacturing engineers typically identified defects at the foundry after a manufacturing run, and then made various changes in the manufacturing process or equipment to eliminate the identified defects from subsequent manufacturing runs. The complexity of modern integrated circuits has led to a dramatic rise in the number of defects for these circuits, however. At nanometer geometries, for example, these defects often occur only as a result of the interaction between the design and the process, rather than from a correctable deficiency in the manufacturing process itself. It has therefore become increasingly difficult to increase manufacturing yield by changing the manufacturing process or equipment at the foundry.

To address this problem, yield improvement solutions are being pushed upstream into the design process. More particularly, by understanding how various design features interact with the manufacturing process to produce defects, a designer can avoid or modify these design features to reduce the occurrence of fault-creating defects in the manufactured circuit. Accordingly, it would be beneficial to accurately identify design changes that can be made to a circuit design that would optimize the manufacturing yield of an integrated circuit. Further, it would be useful for a designer to be able to optimize the manufacturing yield of an integrated circuit while also ensuring that the manufactured circuits comply with defined constraints.

### BRIEF SUMMARY OF THE INVENTION

Advantageously, various examples of the invention provide techniques for improving the design of circuits, such as integrated microcircuits. With some implementations of the invention, a proposed circuit design is analyzed to identify design features associated with yield loss in manufactured circuits (that is, features associated the occurrence of defects during the manufacturing process). For example, the analysis may identify design features that have a significant probability of being improperly formed during a manufacturing process. Next, any design changes that will reduce the yield losses associated with the yield loss features are determined. That is, various changes to the circuit design are determined that, when implemented, will reduce or eliminate the likelihood of a defect occurring in a circuit manufactured from the design.

Depending upon the specific features of the circuit design data, multiple design changes to reduce the yield loss may be identified. In some instances, two or more of these design changes may be mutually exclusive, so that only a smaller subset of the identified design changes can actually be implemented. Accordingly, once the design changes have been determined, the design changes that will optimize the manufacturing yield of the circuit are selected. With various examples of the invention, the design changes may be manually selected, automatically selected, or both. Once the design changes have been selected, then the microcircuit design is revised to incorporate the selected design changes. This analysis and revision process may then be repeated for each revised circuit design, until no further reduction in the manufacturing yield loss can be obtained.

With some implementations of the invention, the implemented design changes will be selected based upon defined constraints for the manufactured circuit. For example, a designer may specify that the circuit must meet certain timing requirements. If a design change will prevent the circuit from meeting these timing requirements, then that design change will not be selected. Other implementations of the invention may alternately or additionally select the implemented design changes based upon desired target characteristics for the manufactured circuit. For example, a designer may wish to maximize the microcircuit's ability to dissipate heat. Accordingly this target data may encourage the selection of design changes that will improve heat dissipation, such as widening of connective lines, over the selection of design changes that will have no affect on the circuit's ability to dissipate heat.

### BRIEF DESCRIPTION OF THE DRAWINGS

FIG. 1 illustrates an example of a computing device that may be employed to implement various examples of the invention.

FIGS. 2A-4C illustrate examples of yield loss features and corrective design changes corresponding to those yield loss features.

FIG. 5 illustrate a tool for identifying yield loss features in a circuit design and selecting corresponding corrective design changes according to various examples of the invention.

FIGS. 6A and 6B illustrate a flowchart describing a method of identifying yield loss features in a circuit design and selecting corresponding corrective design changes according to various examples of the invention.

### DETAILED DESCRIPTION OF THE INVENTION

Operating Environment

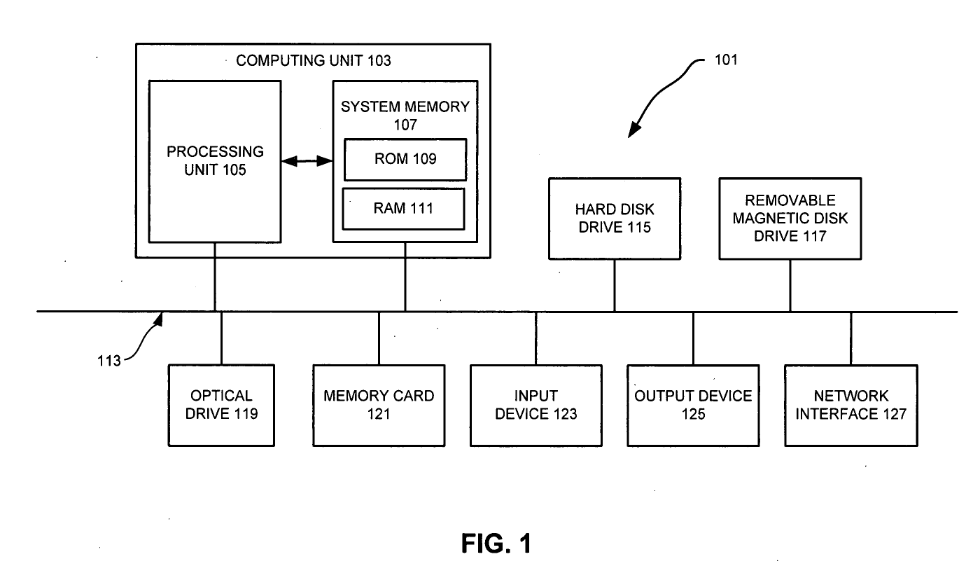

Various examples of the invention may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1.

Yield Loss Features and Fixes

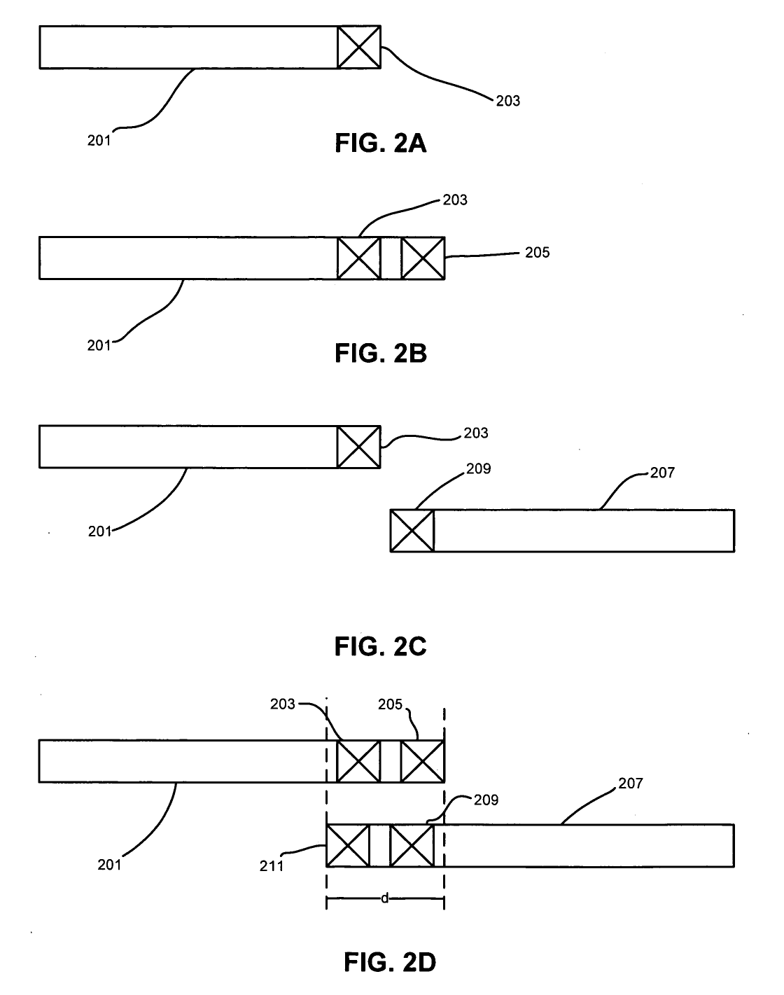

As noted above, various features of a circuit design will be associated with the occurrence of defects that reduce the manufacturing yield of the circuit. These “yield loss” features may include design data representing a discrete circuit structure. For example, FIG. 2A illustrates a conductive line or wire 201 with a single via 203. In this example, the single via 203 may be a yield loss feature. As known in the art, a via is an electrical connection between separated layers of conductive material. More particularly, when two conductive layers are separated by one or more non-conductive layers, a via is created by forming a hole through the non-conductive layers. This hole is then filled with conductive material. In this manner, connective wires on two separate layers of conductive material can be electrically connected through a via.

A number of defects can arise during the manufacture of a via, however. If the area defined for the via is too small, then the hole between the non-conductive layers may not be completely formed during the manufacturing process. Also, if the wires in each conductive layer are not accurately aligned, then the via may have only limited contact or no contact at all with one of the wires. Either defect may produce an unacceptably high resistance, or even a break in the circuit. Accordingly, depending upon the manufacturing process, single vias below a threshold size may have a significant likelihood of causing a defect. Also, the probability of a via causing a defect will typically increase as the size of the via decreases.

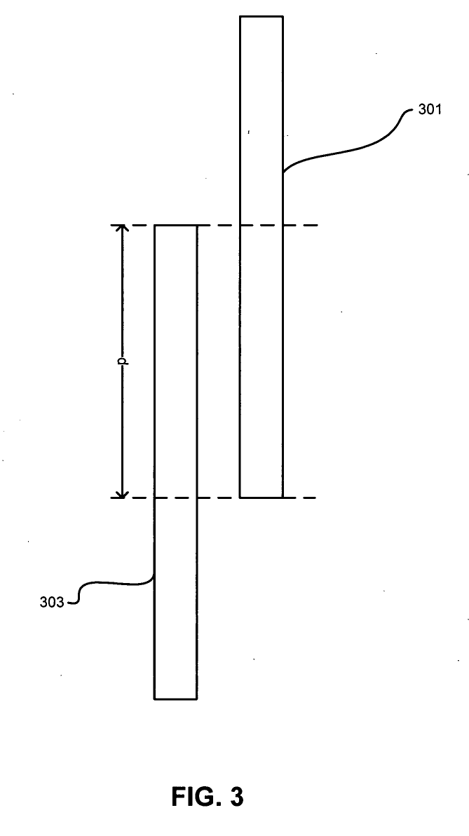

Yield loss features also may include design data representing a relationship between two separate circuit structures. For example, FIG. 3 illustrates two parallel wires 301 and 303. By itself, either wire 301 or 303 might be reliably be formed by a manufacturing process. If the two parallel wires 301 and 303 are within a threshold distance of each other, however, the manufacturing process may inadvertently cause the wires to run together. Thus, the relationship between the parallel wires 301 and 303 may have a significant likelihood of causing a bridging defect between the wires. In this example, the yield loss feature thus may be a relationship where two wires are parallel, within a threshold distance of each other, and have an overlap of d along their primary direction.

It should be appreciated that the yield loss features described above are presented for illustrative purposes only, and are not intended to be limiting. In fact, there are a wide range of yield loss features known in the art. Some yield loss features may depend upon a wide variety of design data. For example, with some manufacturing processes, even if the wires 301 and 303 are within a threshold distance and have an overlap d, a bridging defect may be unlikely to occur unless the overlap d also is over a threshold distance.

Further, whether a design feature is a yield loss feature will often depend upon the specific manufacturing process that will be used to manufacture a circuit from the design. Thus, a single via of a particular size may have significant likelihood of causing a defect with one manufacturing process, but be extremely unlikely to cause a defect with another manufacturing process. Still further, new yield loss features are continually being discovered, particularly with regard to relationships between separate circuit structures. Accordingly, as used herein, the term yield loss feature will include any combination or aspects of design data that has a threshold probability of causing a defect with a given manufacturing process, where the threshold probability and given manufacturing process may be selected by a designer or other person using an embodiment of the invention.

Many yield loss features will have one or more known “fixes” or corrective design changes that will help correct the problems caused by the yield loss feature. In some instances, the corrective design change may reduce the impact that a defect caused by the yield loss feature will have on the total manufacturing yield of the circuit. For example, with the single via 203 illustrated in FIG. 2A, the circuit design may be changed to include a redundant via 205 as shown in FIG. 2B. While each via 203 and 205 may have a significant likelihood of causing a defect, the likelihood of both vias 203 and 205 failing to be properly formed and causing a defect will be substantially smaller. For example, if each via has a 1×10⁻⁹ probability of causing defect, the probability of both vias 203 and 205 causing a defect then will only be 1×10⁻¹⁸. This technique, often referred to as “via doubling,” will thus ameliorate the impact of a defect caused by any particular via being improperly formed during the manufacturing process.

Still other design changes may remove the yield loss feature from a circuit design altogether. For example, with the parallel wires 301 and 303 illustrated in FIG. 3, a conventional fix is to simply increase the distance between the wires. If the wires are separated by more than the threshold distance, then the likelihood of the wires bridging will correspondingly be reduced to below an amount considered significant. In this manner, the yield loss feature is removed from the circuit design in favor of another design feature that does not have a significant likelihood of causing a defect.

In some instances, however, a corrective design change intended to fix one type of yield loss feature may actually cause another type of yield loss feature. For example, FIG. 2C illustrates a second wire 207 with a single via 209 parallel to the first wire 201. Via doubling might then add a redundant via 205 to the wire 201, and a redundant via 211 to the wire 207. While this configuration theoretically will prevent the failure of any particular via 203, 205, 209 and 211 from having an impact on the operation of the manufactured circuit, the via doubling also increases the likelihood of the parallel wires 201 and 207 bridging together during the manufacturing process. Thus, in an attempt to address the single via-type yield loss features in a design, the corrective design change inadvertently created the parallel wire bridging type yield loss feature illustrated in FIG. 3.

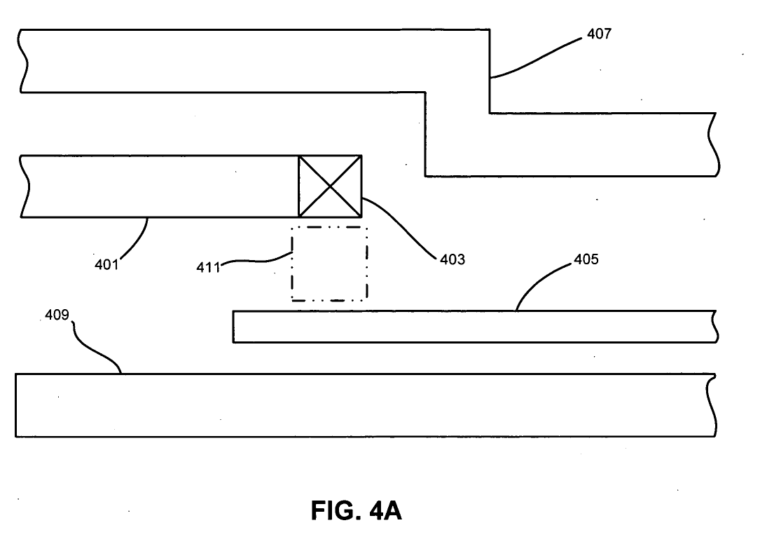

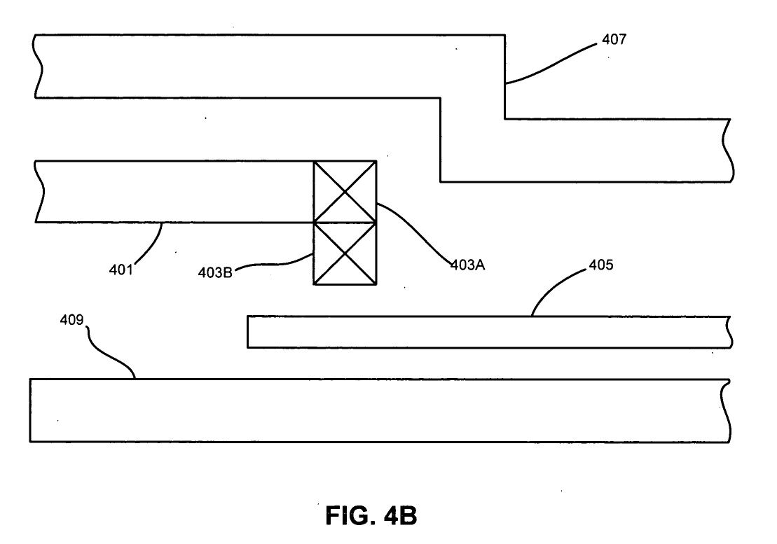

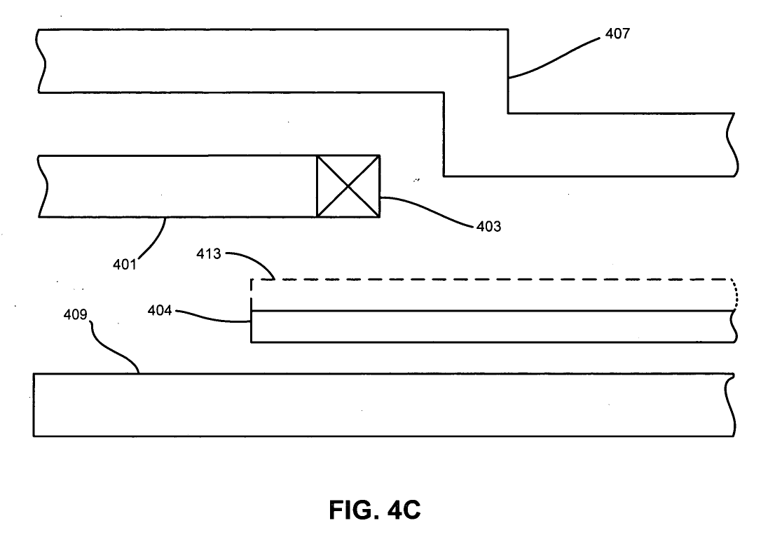

Further, different corrective design changes may be mutually exclusive. For example, FIG. 4A illustrates a portion of a circuit including a wire 401 with a single via 403A. It also illustrates a wire 405 that is too thin to be reliably manufactured. The corrective design change associated with the single via 403A is to add a second via 403B, as discussed in detail above. Because of the proximity and shape of adjacent wire 407, however, the via 403B can only be added in the space 411 between the wire 401 and the wire 405, as shown in FIG. 4B. On the other hand, the corrective design change associated with the thinness of the wire 405 is to expand the width of the wire 405 to include area 413, as shown in FIG. 4C. As may be seen from this figure, however, the area 413 includes at least a portion of the area 411 required to create the redundant via 403B. Accordingly, both corrective design changes cannot be implemented for the illustrated circuit portion.

As will be discussed in greater detail below, various examples of the invention analyze a circuit design to identify yield loss features in the design. The also will determine the corrective design changes associated with the identified yield loss features. Once the corrective design changes have been determined, these examples of the invention will select the combination of corrective design features that will minimize yield loss in the manufactured circuits. With some implementations of the invention, the combination of corrective design features may be automatically selected using any desired selection technique, including, for example, a weighting selection algorithm, a Monte Carlo selection algorithm, a genetic selection algorithm, or the use of a neural network. In this manner, corrective design data can be selected that will optimize the yield of the manufactured circuits.

Moreover, once the set of corrective design features has been selected and incorporated into the original circuit design, various examples of the invention may repeat the analysis and corrective design change selection process until the yield loss cannot be reduced further. Thus, even if a selected set of corrective design changes inadvertently creates new yield loss features in the circuit design data, subsequent analyses and corrective design changes can address the new yield loss features.

Yield Optimization Tool

As noted above, various embodiments of the invention may be implemented by the execution of software instructions with a programmable computer. For example, some embodiments of the invention may be implemented using a software application for identifying and manipulating structures defined in a circuit layout design, such as the CALIBRE® verification and manufacturability software tools available from Mentor Graphics® Corporation of Wilsonville, Oreg. It should be appreciated, however, that other software tools for identifying and manipulating structures defined in a circuit layout design are known in the art, and thus may be used to implement various examples of the invention. Further, a user may employ separate software tools in combination to implement various examples of the invention. For example, a user may employ one or more software tools, such as the CALIBRE® verification and manufacturability software tools, to identify yield loss features, and use on or more other software tools, such as proprietary software tools, to associate corrective design changes with identified yield loss features, or vice versa.

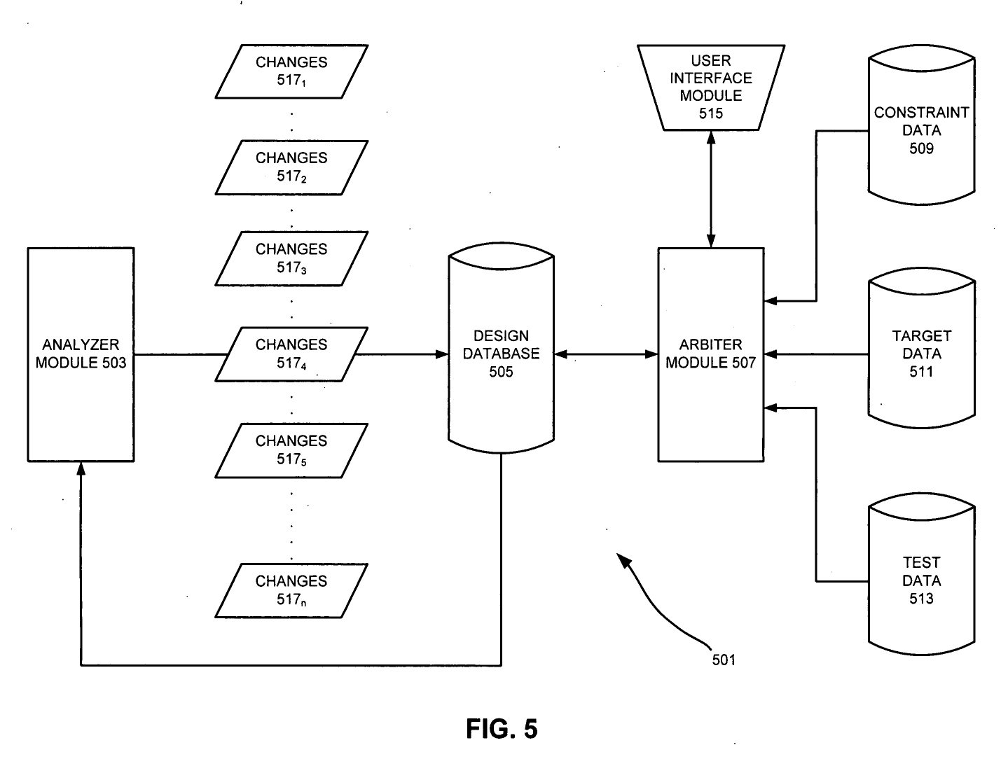

FIG. 5 illustrates an example of a yield optimization tool 501 that may be employed according to various examples of the invention. As seen in this figure, the yield optimization tool 501 includes an analyzer module 503, a design database 505, and an arbiter module 507. With various embodiments of the invention, the yield optimization tool 501 may also employ some combination of constraint data 509, target data 511, and test data 513. Some examples of the yield optimization tool 501 also may optionally include a user interface module 515, as will be discussed in more detail below. Each of the modules 501-507 and 515 may be implemented by the execution of software instructions on a programmable computer.

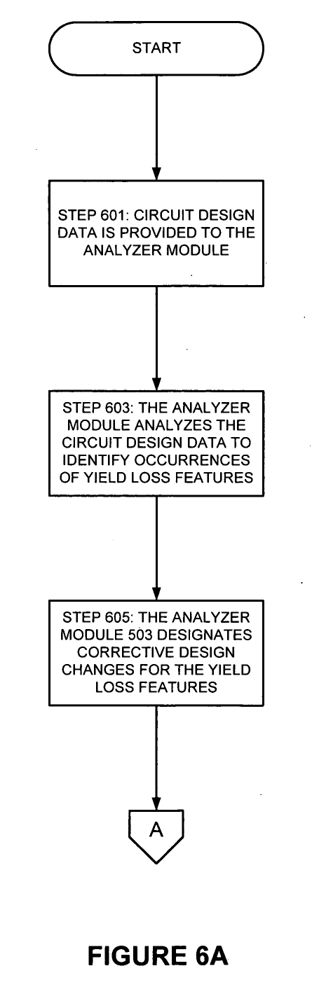

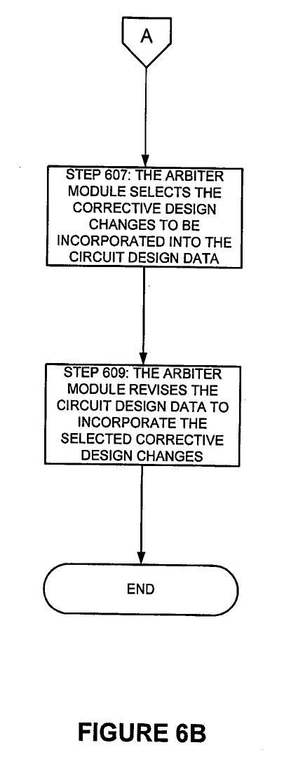

The operation of the yield optimization tool 501 will be described with reference to the flowchart illustrated in FIGS. 6A and 6B. Initially, in step 601, circuit design data, such as layout design data, is provided to the analyzer module 503. The circuit design data may be provided directly to the analyzer module 503. Alternately, the analyzer module 503 may retrieve the circuit design data from the design database 505. With various examples of the invention, the circuit design data may be in any desired type of data format, such as GDS-II, Oasis, Open Access, Milkyway, LEF/DEF, or Volcano. The circuit design data may describe an entire circuit, or it may describe only a portion of a circuit.

Next, in step 603, the analyzer module 503 analyzes the circuit design data to identify the occurrences of yield loss features in the circuit design data. For example, some embodiments of the yield optimization tool 501 may be implemented using software tools for identifying and manipulating structures defined in a circuit layout design, such as the CALIBRE® verification and manufacturability software tools available from Mentor Graphics® Corporation of Wilsonville, Oreg., as noted above. These types of software tools can analyze layout design data to identify specific design features, such as, for example, particular types of circuit structures, distances between circuit structures, and the sizes of circuit structures. Using this functionality, these verification and manufacturability software tools can be employed to identify particular design features or combinations of design features that have previously been designated as yield loss features.

For example, the CALIBRE® verification and manufacturability software tools can be used to identify each occurrence of wires connected between non-conductive layers by only a single via. They also can be used to identify the occurrence of parallel wires that are within a specified distance and overlap in their primary direction by a specified amount. It should be appreciated, however, that the particular data design features (or combination of data design features) designated as yield loss features will vary depending upon the manufacturing process that will be used to manufacture circuits from the design. Also, the particular data design features (or combination of data design features) designated as yield loss features may vary depending upon the amount of yield loss that will be acceptable to the circuit manufacturer, the amount of processing time that the user is willing to devote to optimizing the yield of circuit manufactured from the design, or any other practical considerations.

The yield loss features may be designated by a designer using the yield optimization tool 501, by the manufacturer or distributor of the yield optimization tool 501, or by any other desired source. Further, yield loss feature definitions from different sources may be combined. In some instances, the defined yield loss features will include any known data design features (or combination of data design features) that have a significant probability of causing a defect in the manufactured circuit. Alternately, the defined yield loss features may include only those data design features (or combination of data design features) that the user of the tool 501 believes are relevant to the circuit design data being analyzed.

For example, a data design feature, such as a thin wire, may have a relatively high probability of causing a defect. If this feature occurs only once or twice in the design data, however, then it may not be designated as a yield loss feature. On the other hand, another design data feature, such as a single via, may have a relatively low likelihood of causing a defect. If that second design data feature has a large number of occurrences in the design data, however, then it may still impact the total manufacturing yield of the circuit and thus may be designated as a yield loss feature. Still further, even if a particular data design feature (or combination of data design features) has a significant likelihood of causing a defect, it may not be designated as yield loss features if there are no known or available corrective design changes that can be used to ameliorate the impact of this feature on the overall manufacturing yield.

After the analyzer module 503 has identified every occurrence of a yield loss feature in the design data, it designates corrective design changes 517 for those yield loss features in step 605. More particularly, for each identified yield loss feature, the analyzer module 503 will review a group of available corrective design changes, to determine if there are one or more corrective design changes that, when incorporated into the circuit design data, will reduce the yield loss associated with that yield loss feature. The group of available corrective design changes may be specified by a designer using the yield optimization tool 501, by the manufacturer or distributor of the yield optimization tool 501, or by any other desired source.

It should be appreciated that, while a corrective design change may be known to a user of the yield optimization tool 501, it may not actually be available to the analyzer module 503 for designation because of intellectual property restrictions, limitations in the manufacturing process, etc. With some embodiments of the invention, the available corrective design changes may be provided directly to the analyzer module 503, retrieved from the design database 505, or retrieved from some other source.

Some yield loss features may have more than one corresponding corrective design change. For example, single vias may be doubled, as discussed in detail above. An alternate corrective design change for this yield loss feature, however, may be to increase the size of each single via by 33%. With some examples of the invention, if a yield loss feature does have more than one corresponding corrective design change, then the analyzer module 503 will designate every such corresponding corrective design change as a corrective design change 517 for that yield loss feature. With other examples of the invention, however, the analyzer module 503 may only designate a single corresponding corrective design change that will reduce the impact of that yield loss feature on the manufacturing yield by the greatest amount.

Also, as previously noted, some of the designated corrective design changes 517 may conflict with other designated corrective design changes 517. For example, implementing a corrective design change 517 that doubles every single via in the circuit design data may prevent the implementation of a corrective design change 517 that widens wires in some portions of the circuit design data. Thus, some corrective design changes 517 may reduce the yield loss related to particular yield loss features, but increase the overall yield loss for manufacturing the circuit by increasing the cost of implementing (or even excluding the implementation) of other corrective design changes 517 that would have a greater impact in reducing the yield loss in manufacturing the circuit.

In order to determine which combination of corrective design changes 517 will provide the greatest overall decrease in yield loss for the manufactured circuit, various examples of the invention will associate at least one impact value with each corrective design change 517. As will be discussed in more detail below, the arbiter module 507 will use these impact values to determine which of the designated corrective design change 517 will be incorporated into the circuit design data. The impact value for a corrective design change 517 may be any value that will be useful in evaluating the benefit of selecting that corrective design change 517 for incorporation into the circuit design data.

The impact value may represent, for example, the reduction in the likelihood that each occurrence of the corresponding yield loss feature will cause a defect after the corrective design change 517 is implemented. Thus, if implementing the corrective design change 517 will reduce the probability of a single occurrence of the yield loss feature causing a defect by 80%, then the corrective design change 517 may have an impact value of 80%. This type of impact value may be useful where, e.g., the arbiter module 507 selects a different set of corrective design changes 517 for different locales of the circuit design data, as will be discussed in more detail below.

Alternately, the impact value may represent the overall reduction in yield loss that will be obtained from implementing the corrective design change 517. For example, a yield loss feature may have a large number of occurrences in the circuit design data. Even if the corrective design change 517 will only reduce the probability of a single occurrence of the yield loss feature causing a defect by a small amount, the cumulative effect on yield loss for the circuit may be relatively large. Accordingly, the corrective design change 517 would have a relatively large impact value. This type of impact value may be useful where, e.g., the arbiter module 507 selects a single set of corrective design changes 517 for the all of the circuit design data.

Further, a corrective design change 517 may have a global impact value, a plurality of local impact values, or some combination of both. A global impact value will be a value useful in evaluating the benefit of selecting that corrective design change 517 for global incorporation into the circuit design data (i.e., incorporation into all of the circuit design data). A local impact value, however, will be a value useful in evaluating the benefit of selecting that corrective design change 517 for incorporation into specific locales of the circuit design data. The locale may be any desired subset of the circuit design data, such as a portion of the circuit design data representing a particular geographic region of the circuit, a layer of the circuit, a netlist, a hierarchical cell, or specific structures within the circuit design data (e.g., all single vias smaller than a defined size or even a specific via).

With various embodiments of the invention, the designated corrective design changes 517 may be stored in the design database 505. Thus, the design database 505 may store each corrective design change 517 as alternate data for the circuit design data. In still other embodiments of the invention, the designated corrective design change 517 may be provided directly to the arbiter module 507.

In step 607, the arbiter module 507 selects which of the designated corrective design changes 517 will be incorporated into the circuit design data. For example, with the corrective design change 517₁-517ₙ shown in FIG. 5, the arbiter module 507 may select corrective design changes 517₁, 517₂, 517₄ and 517₅, but not corrective design change 517₃ or 517ₙ. Then, in step 609, the arbiter module 507 revises the circuit design data to incorporate the selected corrective design changes 517.

As previously noted, the arbiter module 507 typically will attempt to select the combination of identified corrective design changes 517 that will provide the overall greatest decrease in yield loss (i.e., the highest increase in yield) when the circuit is manufactured. According to different implementations of the invention, the arbiter module 507 may employ any desired technique or criteria to make this cost-benefit analysis selection. With various embodiments of the invention, the arbiter module 507 will automatically select the set of corrective design changes 517 to be incorporated into the circuit design data based upon the impact values for each corrective design change 517.

For example, the arbiter module 507 may employ a simple weighting algorithm to select corrective design changes 517. The arbiter module 507 then will identify the corrective design change 517 having the highest impact value, and revise the circuit design data to implement that corrective design change 517 wherever possible. The arbiter module 507 next will identify the corrective design change 517 having the next highest impact value, and revise the circuit design data to implement that corrective design change 517 wherever possible. This process may then be repeated for every designated corrective design change 517, or until no further corrective design changes 517 can be made to the circuit design data because of space limitations. Moreover, if two corrective design changes 517 are mutually exclusive, then only the corrective design change 517 with the higher impact value will be incorporated into the circuit design data.

It should be appreciated that more sophisticated embodiments of the yield optimization tool 501 may employ any desired type of selection algorithm for selecting the corrective design changes 517 that will be incorporated into the circuit design data. For example, some implementations of the yield optimization tool 501 may use some type of Monte Carlo or simulated annealing selection algorithm. As known in the art, with this type of selection algorithm selection candidates are chosen at random, and variations of the selection combination are compared with each other until an optimum combination is identified. Other implementations of the yield optimization tool 501 may use some type of genetic selection algorithm. With this type of selection algorithm, different combinations of selection candidates are mutated and mated with each other to produce new generations of selection candidate combinations, and a selection function determines which combinations of selection candidates will survive to a next generation.

The arbiter module 507 may employ still other algorithms and techniques to select corrective design changes 517 according to various embodiments of the invention. For example, with some implementations of the yield optimization tool 501, the arbiter module 507 may use a neural network or modeling to select corrective design changes 517 for incorporation into the circuit design data. It should be appreciated that some selection algorithms or techniques may obviate the need to associate an impact value with each designated corrective design change 517. For example, the neurons of a neural network may employ its own internal weighting values relevant to each corrective design change 517 and the number of occurrences of its corresponding yield loss feature in the circuit design data.

The particular selection algorithm or technique (or combination of selection algorithms or techniques) employed by the arbiter module 507 may be chosen by a designer using the yield optimization tool 501, by the manufacturer or distributor of the yield optimization tool 501, or by any other desired source. With some examples of the invention, if a designer using the yield optimization tool 501 is dissatisfied with an existing selection algorithm or technique, or believes that it is inappropriate for a particular circuit design, then the designer can plug in a more desirable selection algorithm or technique for use by the arbiter module 507.

It also should be appreciated that the arbiter module 507 may make global selections of corrective design changes 517, local selections of corrective design changes 517, or both. For example, the arbiter module 507 may select one set of corrective design changes 517 to be incorporated into one circuit schematic (e.g., a netlist) in the circuit design data, and a different set of corrective design changes 517 to be incorporated into another circuit schematic in the circuit design data. With various examples of the invention, the arbiter module 507 may make local selections based upon any desired locale, such as a portion of the circuit design data representing a particular geographic region of the circuit, a layer of the circuit, a netlist, a hierarchical cell, or specific structures within the circuit design data (e.g., all single vias smaller than a defined size or even a specific via). Also, as noted above, the arbiter module 507 may combine global selections with local selections. Thus, the arbiter module 507 may select a global set of corrective design changes 517 that can be implemented throughout the circuit design data, and then additionally select local sets of corrective design changes 517 that are appropriate to the corresponding locale.

As previously noted, each selected corrective design change 517 is incorporated into the circuit design data, typically wherever possible. With some embodiments of the invention, each occurrence of a corrective design change 517 may be flagged to prevent the change from being undone by the implementation of subsequently selected corrective design changes 517. Each occurrence of a corrective design change 517 also may be flagged to allow for “rollback” (i.e., reversal) of that change, as will be discussed below.

Once all of the selected corrective design changes 517 have been incorporated into the circuit design data, then the circuit design data may be output for use in manufacturing the circuit. The circuit design data may be output in any desired format, such as such as GDS-II, Oasis, Open Access, Milkyway, LEF/DEF, or Volcano.

It should be appreciated, however, that an increase in manufacturing yield expected from implementing the selected corrective design changes 517 might not actually be realized by the revised circuit design data. For example, due to space considerations, only a few occurrences of a corrective design change 517 may be added to the circuit design data, even though its corresponding yield loss feature has a large number of occurrences throughout the circuit design data. Also, as discussed in detail above, implementing a corrective design change, may inadvertently create new yield loss features. Accordingly, with some embodiments of the invention, the revised circuit design data is provided back to the analyzer module 503, and steps 601-609 are repeated.

In this manner, the yield optimization tool 501 can continue to revise the circuit design data in order to further reduce the yield loss of circuits manufactured from the circuit design data. With some embodiments of the invention, the yield optimization tool 501 may simply add corrective design changes to the circuit design data in subsequent iterations of the analysis and revision process. For still other embodiments of the invention, the yield optimization tool 501 may roll back previously incorporated corrective design changes, either globally or locally, where the corrective design change did not have the desired impact on the yield loss for the circuit design data.

Selection Control

Various example of the invention may allow the user of the yield optimization tool 501 to exercise greater control over the selection and implementation of the corrective design changes 517 than provided by the selection algorithm or technique used by the arbiter module 507. More particularly, some examples of the invention may employ selection control data to control which corrective design changes 517 are selected by the arbiter module 507. For example, some embodiments of the yield optimization tool 501 may employ constraint data 509 to control how the corrective design changes 517 are selected or implemented. More particularly, the constraint data 509 will include parameters for the circuit that will constrain the selection or implementation of the corrective design changes 517. For every selected corrective design change 517, the arbiter module 507 will thus determine whether the implementation of that corrective design change 517 will violate a specified constraint.

With some embodiments of the invention, the arbiter module 507 may further determine whether the implementation of that corrective design change 517 will contribute an unacceptable amount to the violation of a specified constraint. If the arbiter module 507 determines that the unrestricted implementation of a corrective design change 517 would violate a constraint (or unacceptably contribute to the violation of a constraint), then the arbiter module 507 may implement the corrective design change 517 on only a limited basis (i.e., to occurrences that will not violate the constraint). Alternately, the arbiter module 507 may discard the corrective design change 517 altogether.

For example, the constraint data 509 may specify minimum timing requirements for circuit devices in circuit design data. Further, the circuit design data itself may include data representing a metal layer with a non-uniform density across its surface. If the analyzer module 503 identifies this non-uniform surface density as a yield loss feature, it may designate a corrective design change 517 that adds material fill to the layer. More particularly, this type of corrective design change 517 adds unconnected polygons of material across the layer, to ensure that the layer provides a level surface to support upper layers of material.

While this corrective design change 517 may address the problems created by a non-uniform surface density, each of the unconnected fill polygons will have a capacitance that will change the timing parameters of surrounding circuit devices. If the capacitance created by the fill polygons causes a circuit device to exceed a minimum timing requirement specified in the constraint data 509, then the arbiter module 507 may not add the fill polygons to the circuit design data, and instead discard this corrective design change 517. Alternately, the arbiter module 507 may identify particular fill polygons based upon some appropriate criteria, and refrain from adding those polygons to the circuit design data. For example, the arbiter module 507 may identify and eliminate the fill polygons with the largest capacitance, the fill polygons closest to the affected circuit device, etc., to avoid violating the timing requirements in the constraint data 509.

It should be appreciated that any desired parameters may be included in the constraint data 509. For example, the constraint data 509 may alternately or additionally include power distribution requirements, noise limitations, heat or thermal dissipation requirements, electromigration limitations, metal flow limitations, or design rule requirements. The particular parameters included in the constraint data 509 may be specified by a designer using the yield optimization tool 501, by the manufacturer or distributor of the yield optimization tool 501, or by any other desired source. Further, constraint data 509 parameters from different sources may be combined.

It also should be appreciated that the constraint data 509 may include global constraints, local constraints, or a combination of both. For example, the constraint data 509 may include a lower noise limit for a particularly sensitive subcircuit of devices. The constraint data 509 may then specify a higher global noise limit for the remaining devices in the circuit. The locale for a local constraint may be any desired subset of the circuit design data, such as a portion of the circuit design data representing a particular geographic region of the circuit, a layer of the circuit, a netlist, a hierarchical cell, or specific structures within the circuit design data (e.g., all single vias smaller than a defined size or even a specific via).

In addition to the constraint data 509, various embodiments of the invention may allow a designer using the yield optimization tool 501 (or any other desired source) to designate tools used to check compliance with the constraint data 509. For example, a designer using the yield optimization tool 501 may specify a favorite timing tool. When the arbiter module 507 then checks to see whether a corrective design change 517 will violate timing constraints in the constraint data 509, the arbiter module 507 will use the specified timing tool to determine how incorporating the corrective design change 517 would affect the timing of the circuit design data.

Some embodiments of the invention may alternately or additionally allow a designer using the yield optimization tool 501 to employ target data 511 to control the selection of designated corrective design changes 517. While constraint data 509 define parameters for the circuit design data that cannot be violated, the target data 511 includes parameters that encourage the selection or implementation of certain corrective design change 517. For example, a designer designing a microprocessor circuit for laptop computers may wish to maximize thermal dissipation in the circuit. Accordingly, the designer may specify a target heat dissipation value in the target data 511. If a corrective design change 517, such as widening of connective lines, will improve heat dissipation, then the arbiter module 507 may implement this corrective design change 517 in favor of another corrective design change 517 that will have no affect on the circuit's ability to dissipate heat. Depending upon the target enforcement criteria designated by the designer using the yield optimization tool 501 and the selection algorithms or techniques employed by the arbiter module 507, the arbiter module 507 may even select a corrective design change 517 that increases compliance with target data 511 over a corrective design change 517 that provides a greater reduction in yield loss.

As with the constraint data 409, the particular parameters included in the target data 511 may be specified by a designer using the yield optimization tool 501, by the manufacturer or distributor of the yield optimization tool 501, or by any other desired source. Further, target data 511 parameters from different sources may be combined. It also should be appreciated that the target data 511 may include global targets, local targets, or a combination of both. Again, the locale for a local target may be any desired subset of the circuit design data, such as a portion of the circuit design data representing a particular geographic region of the circuit, a layer of the circuit, a netlist, a hierarchical cell, or specific structures within the circuit design data (e.g., all single vias smaller than a defined size or even a specific via). It should be appreciated that any desired parameters may be included in the target data 511. For example, the target data 511 may alternately or additionally include power distribution targets, noise limit targets, electromigration limit targets, metal flow limit targets, or design rule targets.

Still further, some embodiments of the invention may alternately or additionally permit a designer using the yield optimization tool 501 to control the selection of designated corrective design changes 517 based upon test data 511. For example, the designer may have test data 511 from the foundry that will be manufacturing the circuit using the circuit design data. If this test data 511 indicates, for example, that a particular corrective design change 517 cannot be properly manufactured by the foundry, then the arbiter module 507 may lower the selection priority of this corrective design change 517, or eliminate it from selection altogether.

Some examples of the yield optimization tool 501 may optionally include a user interface module 515, as previously noted. The user interface module 515 allows a designer using the yield optimization tool 501 to override or modify selections made by the arbiter module 507. More particularly, the user interface module 515 may be employed to implement a corrective design change 517 for specific portions of the circuit design data, including, e.g., a single occurrence of the representation of a specific circuit structure. For example, from previous manufacturing runs, a designer may be aware of a high bridging defect rate for parallel wires in a particular region of the circuit. The designer can then employ the user interface module 515 to ensure that a corrective design change 517 corresponding to this defect is implemented for at least that region of the circuit.

With some embodiments of the invention, the user interface module 515 may even be used to implement a corrective design change that was not designated by the analyzer module 503. For example, a designer may be aware of a design feature that has not been identified as a yield loss feature, but which is nonetheless causing defects in circuits manufactured from the circuit design data. The designer can then employ the user interface module 515 to implement an appropriate design change to the circuit design data that will prevent or otherwise ameliorate the impact of the noted defects. Further, the user interface module 515 also may be employed to reverse or limit the implementation of a corrective design change 517 already selected by the arbiter module 507.

Thus, various examples of the invention provide methods and techniques for optimizing the yield of manufactured circuits by identifying yield loss features in the circuit design, and then selectively revising the circuit design to incorporate corrective design changes that reduce or eliminate the impact of the yield loss features. It also should be appreciated that, while various examples of the invention have been described with particular reference to the design and manufacture of integrated circuits, various aspects and features of the invention may be applicable to the design and manufacture of other types of circuits, such as circuits on circuits. Still further, various aspects and features of the invention may be applicable to the design and manufacture of other types of microdevices, such as microeletromechanical (MEM) devices.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A method of improving a manufacturing yield of circuits, comprising:
analyzing a circuit design to identify yield loss features, such that each yield loss feature is associated with a yield loss in circuits manufactured from the circuit design;
designating a plurality of corrective design changes for the circuit design, such that each corrective design change, when incorporated into the circuit design, reduces the yield loss associated with at least one of the yield loss features;
automatically selecting a set of the corrective design changes that will increase a yield of manufactured circuits; and
revising the circuit design to incorporate the selected set of corrective design changes.

2. The method recited in claim 1, further comprising:
analyzing the revised circuit design to identify yield loss features;
designating a second plurality of corrective design changes for the revised circuit design;
automatically selecting, from among the second plurality of corrective design changes, a second set of corrective design changes that will increase the yield of manufactured circuits; and
revising the revised circuit design to incorporate the selected second set of corrective design changes.

3. The method recited in claim 1, further comprising automatically selecting the set of corrective design changes based upon constraint data.

4. The method recited in claim 3, wherein the constraint data includes data selected from the group consisting of timing requirement data, power distribution requirement data, noise limitation data, heat limitation data, electromigration limitation data, metal flow limitation data, and design rule data.

5. The method recited in claim 1, further comprising automatically selecting the set of corrective design changes based upon target data.

6. The method recited in claim 5, wherein the target data includes data selected from the group consisting of timing target data, power distribution target data, noise limit data, heat limit data, electromigration limit data, metal flow limit data, and design rule data.

7. The method recited in claim 1, further comprising automatically selecting the set of corrective design changes based upon test data.

8. The method recited in claim 1, wherein the yield loss features are defined based upon the circuit design.

9. The method recited in claim 1, further comprising
receiving user input from a user input interface, and
revising the circuit design based upon the received user input.

10. The method recited in claim 9, further comprising revising the circuit design based upon the received user input to include an unselected corrective design change.

11. The method recited in claim 9, further comprising revising the circuit design based upon the received user input to remove a selected corrective design change.

12. The method recited in claim 1, further comprising automatically selecting the set of corrective design changes to minimize an overall yield loss in manufacturing the circuit.

13. A method of improving a manufacturing yield of circuits, comprising:
analyzing a circuit design to identify yield loss features, such that each yield loss feature is associated with a yield loss in manufactured circuits;
designating a first plurality of corrective design changes for the circuit design, such that each corrective design change, when incorporated into the circuit design, reduces the yield loss associated with at least one of the yield loss features;
selecting, from among the first plurality of corrective design changes, a first set of corrective design changes that will increase a yield of manufactured circuits;
revising the circuit design to incorporate the first set of corrective design changes;
analyzing the revised circuit design to identify yield loss features;
designating a second plurality of corrective design changes for the revised circuit design;
selecting, from among the second plurality of corrective design changes, a second set of corrective design changes that will further increase the yield of manufactured circuits; and
revising the revised circuit design to incorporate the second set of corrective design changes.

14. The method recited in claim 13, further comprising selecting the set of corrective design changes based upon constraint data.

15. The method recited in claim 14, wherein the constraint data includes data selected from the group consisting of timing requirement data, power distribution requirement data, noise limitation data, heat limitation data, electromigration limitation data, metal flow limitation data, and design rule data.

16. The method recited in claim 13, further comprising selecting the set of corrective design changes based upon target data.

17. The method recited in claim 16, wherein the target data includes data selected from the group consisting of timing target data, power distribution target data, noise limit data, heat limit data, electromigration limit data, metal flow limit data, and design rule data.

18. The method recited in claim 13, further comprising automatically selecting the set of corrective design changes based upon target data.

19. The method recited in claim 13, wherein the yield loss features are defined based upon the circuit design.

20. The method recited in claim 13, further comprising
receiving user input from a user input interface, and
revising the circuit design based upon the received user input.

21. The method recited in claim 20, further comprising revising the circuit design based upon the received user input to include an unselected corrective design change.

22. The method recited in claim 20, further comprising revising the circuit design based upon the received user input to remove a selected corrective design change.

23. The method recited in claim 13, further comprising automatically selecting the set of corrective design changes to minimize an overall yield loss in manufacturing the circuit

24. A tool for improving a manufacturing yield of circuits, comprising:
a circuit design analysis module that
analyzes a circuit design to identify yield loss features, such that each yield loss feature is associated with a yield loss in circuits manufactured from the circuit design, and
designates a plurality of corrective design changes for the circuit design, such that each corrective design change, when incorporated into the circuit design, reduces the yield loss associated with at least one of the yield loss features; and
an arbiter module that
selects a set of corrective design changes that will increase a yield of manufactured circuits, and
incorporates the selected corrective design changes into the circuit design.

25. The tool recited in claim 24, further comprising
a user input interface that receives user input for revising the circuit design.

26. The tool recited in claim 24, wherein the arbiter module selects the set of corrective design changes based upon constraint data.

27. The tool recited in claim 26, wherein the constraint data includes data selected from the group consisting of timing requirement data, power distribution requirement data, noise limitation data, heat limitation data, electromigration limitation data, metal flow limitation data, and design rule data.

28. The tool recited in claim 24, wherein the arbiter module selects the set of corrective design changes based upon target data.

29. The tool recited in claim 28, wherein the target data includes data selected from the group consisting of timing target data, power distribution target data, noise limit data, heat limit data, electromigration limit data, metal flow limit data, and design rule data.

30. The tool recited in claim 24, wherein the arbiter module selects the set of corrective design changes based upon test data.
